(19) United States
(12) Patent Application Publication
(10) Pub. No.: US 2022/0028300 A1
(43) Pub. Date: Jan. 27, 2022

(54) MEDICAL TRAINING AID TO SIMULATE LIVE PATIENT EXPERIENCE

(71) Applicant: Leigh Ann McKeehan Delli Colli, Matthews, NC (US)

(72) Inventor: Leigh Ann McKeehan Delli Colli, Matthews, NC (US)

(21) Appl. No.: 16/873,849

(22) Filed: Jul. 22, 2020

(51) Int. Cl. G09B 23/28

(52) U.S. Cl. CPC G09B 23/285

(57) ABSTRACT

A medical training aid to simulate a live, patient experience while learning medical procedures or training with medical needles, products or devices. The wearable apparatus, consisting of multiple layers of materials, with a low profile almost flush to the skin, one layer having a hard surface membrane barrier to prevent needle penetration, fitting around an area of the body and worn by an individual for educational and training.

The present application claims priority to provisional patent application No. 62/497,321 filed on Jul. 22, 2019 INVENTOR: LEIGH ANN MCKEEHAN DELLICOLLI

### BACKGROUND OF THE INVENTION

### 1. Field of the Invention

The present invention is in the field of medical device training aids.

### 2. Discussion of the State of the Art

In the art of educating and training, more particularly educating and training on medical needles, tools, or devices, many different types of models and replicas of human or animal body parts have been developed to provide realistic training. These training aids include full bodies, arms, hands, portable stationary training blocks or a wearable training aid which can be thick, bulky, and most are made from dense material to emulate a patient or a patient's body part.

When it comes to providing realistic training with medical needles and devices, the training aids mentioned above do not fully capture the live patient experience needed to simulate true patient experience or the verbal and non-verbal contact with patients. Nor, do they provide the ability to practice in the most realistic setting and manner to be successful when educating or training on medical devices or product; which is key to understanding, learning, or retaining a new skill.

Another problem with traditional medical training aids is that they are made of dense material, which does not simulate the ease in which a medical needle, tool, or device penetrates the skin of a patient. Similarly, upon removing the needle or medical device, some training tools will fail entirely, due to the density of the material used.

Yet another limitation to current training aids is that they are often heavy and awkward to transport, most often requiring a carrying case, which adds limitations to when and where education and training can be provided.

Therefore, what is clearly needed is a medical education and training aid that solves the problems mentioned above.

### SUMMARY OF THE INVENTION

The problem stated above is that a more realistic patient experience during education and training on medical devices is desired, but conventional training aids are made with dense, thick and/or bulky materials, making them heavy and awkward to transport, do not simulate a low profile surface while also providing the ease in which a medical needle, tool, or device penetrates a patient's skin or is withdrawn from a patient's skin due to the materials used, and does not simulate a realistic live patient interaction experience, which is crucial to educating and training successfully. The inventor therefore considered functional components of a medical training aid, looking for elements and materials that can be used to create a live, realistic patient experience to gain knowledge and understanding of the medical device before using it on a live patient.

The present inventor realized in an inventive moment that if an educator, trainer, or any individual, had the ability to wear an easily transportable medical training aid, with a multiple layered surface, low in profile, simulating a flush surface as with the skin; during education, training or practice for medical products such as, but not limited to blood drawing needles with a medical training aid simulating a live patient experience, retention of the training would be further enhanced for the trainee, giving the ability to repetitiously use the device as if with a live, patient experience. The inventor therefore constructed a unique wearable training aid to simulate a live patient experience, giving an individual the ability to perfect their skills on a device they are learning, as if they are with a live patient.

Accordingly, in one embodiment of the present invention, a wearable training apparatus, having multiple layers, one layer having a hard surface membrane barrier to prevent needle penetration, fitting around an area of the body and worn by an individual, to simulate live patient experience during education or training.

In one embodiment, one or more layers of the materials are combined and can be removed as one piece to allow the exterior of the apparatus to be washed and/or sanitized, or disposed of and replaced.

In one embodiment, the exterior layer is material visually depicting the anatomy of the body part in which the medical training aid is representing.

### BRIEF DESCRIPTIONS OF THE DRAWING FIGURES

FIG. 1 is an elevation view of a medical training aid according to an embodiment of the present invention.

FIG. 2 is a divided top and sectional view of the medical training aid of FIG. 1 according to an embodiment of the present invention.

FIG. 3 is an overhead view of a medical training aid of FIG. 1 worn on the arm according to an embodiment of the present invention

FIG. 4 is an overhead view of a medical training aid worn on the hand according to a further embodiment of the present invention

### DETAILED DESCRIPTION

The inventor provides a unique wearable medical training aid, low profile and almost flush to the surface of the skin of any area of a body part, human or otherwise, easily transportable and used for educating and training on procedures with devices most commonly found in the medical field to simulate a realistic live patient experience. The wearable training aid made of materials to simulate an area of a body part, with or without any type of artificial veins or any other artificial features, interior or exterior of the training device/aid, the ability for fluid to flow through the veins or any other artificial features, the ability to have any futuristic vein sensor, any other artificial features sensor, futuristic skin sensor or any other futuristic technology of any type, that can identify, sense, or feel the manner in which a medical device is inserted, used, withdrawn, training performed, or any other manner in which futuristic technology can alert, indicate, identify, and/or report how, as stated above, a medical needle, tool or device is used. The training aid, worn by any person, or applied to any dummy, or manufactured training apparatus, used for training purposes, has an interior barrier or barriers to prevent penetration of medical needles, tools or devices used to educate, train, and/or practice, for which the person or manufactured apparatus wearing the training device/aid providing a simulated live, realistic patient experience, will be protected from penetration of the medical needle, tools, or devices. The interior layers can be combined allowing one piece to be removed so that the exterior portion of the apparatus can be washed and/or sanitized, or disposed of and replaced. The present invention is described in enabling detail using the following examples, which may describe more than one relevant embodiment falling within the scope of the present invention.

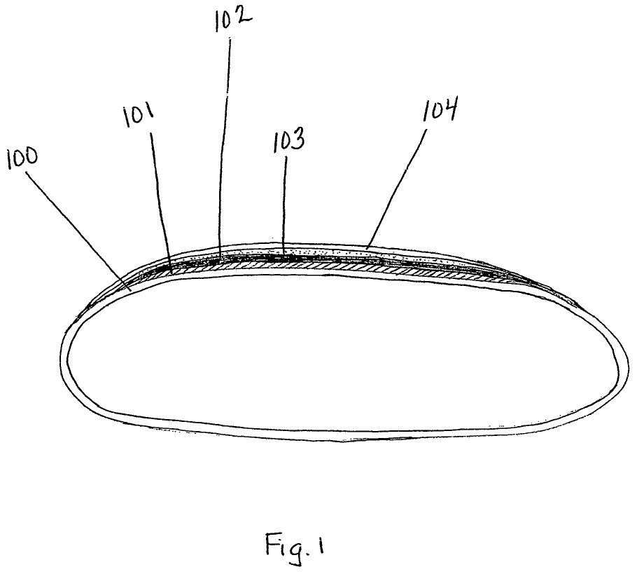

FIG. 1 is an elevation view of a medical training aid 100 according to one embodiment of the present invention. Medical training aid 100 shows a medical training aid to be worn on the arm for educational and training purposes. The example training aid shown worn on the arm should not be construed as a limitation of the invention. Other characterizations for training aid 100 are possible and may be considered according to one or more embodiments of the present invention such as visual depiction of the human or otherwise anatomy for training purposes, with or without the ability to remove some, any, or all of the layers of the training aid to replace, wash, sanitize or exchange for another component, artificial veins or any other artificial features, interior or exterior of the training aid, with or without the ability for fluid to flow, with or without the ability to have any futuristic vein sensor, or any other artificial sensors, skin sensor or any other technology, that can identify, sense, or feel the manner in which a medical device is inserted, used, withdrawn, how training is performed or any other manner in which futuristic technology can alert, indicate, identify, and/or report how, as stated above, a medical needle, tool or device is used. The inventor chooses to represent an arm medical training aid in a preferred embodiment because of its position as a common necessity in the medical field for education and training.

Medical training aid 100 is an easily transportable, wearable band, sleeve, or, but not limited to any other means in which the training aid can be applied to, placed over, laid on, wrapped around, zipped up, seamed together or slipped on to the surface of the skin of any body part, human, animal, or a model or replica of a human being, and used for, but not limited to educating, training, and/or practicing with medical devices and/or procedures to simulate a live realistic patient experience, whereas practiced patient interaction can be achieved. Medical training aid 100 is made with, but not limited to, thin, shapeable, flexible, material, providing a low profile to the skin, designed to fit an area of any body part.

In a preferred embodiment of training aid 100 consists of five layers which includes over 100 is 101 a layer of material specifically designed to help resist penetration of sharp, pointed tips of any needle or other small sharp instruments, over 101 is 102 a layer of hard surface material to provide a protective membrane barrier to prevent penetration of any sharp, pointed tips of any needle or other small sharp instruments, over 102 is 103 a layer of padding, such as, but not limited to cotton or polyester batting to resemble the slight give similar to the fleshiness of the skin, over 103 is 104 outer material covering the layers; the area in which the educator, trainer or any individual is using to provide the live patient experience by allowing the trainee to insert the needle or medical device into the medical training aid as if with a patient.

In one embodiment of the invention 104 is made of material visually depicting the anatomy of the body part in which the medical training aid is representing.

In one embodiment of the invention, any or all of 101, 102, 103 is combined into one piece, can be removed, and allows the outer 100 and 104 areas to be washed, sanitized, or disposed of, without departing from the spirit and scope of the present invention.

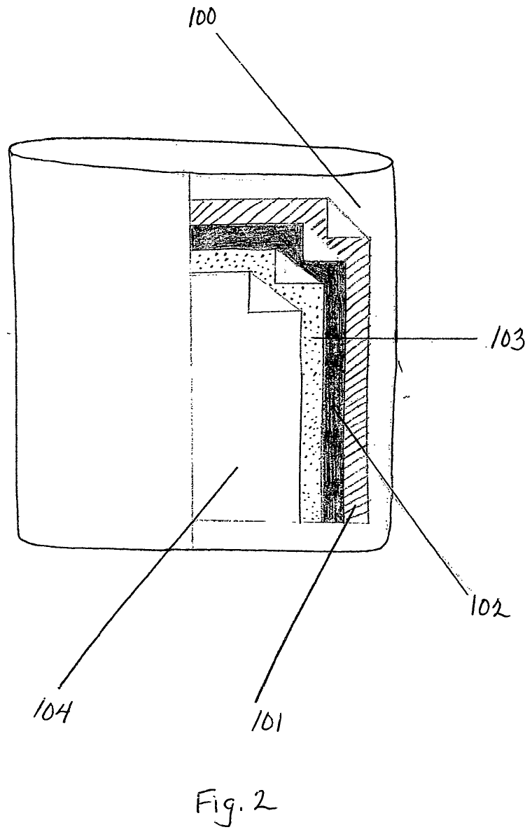

FIG. 2 is a divided top and sectional view of the medical training aid of FIG. 1 according to an embodiment of the present invention.

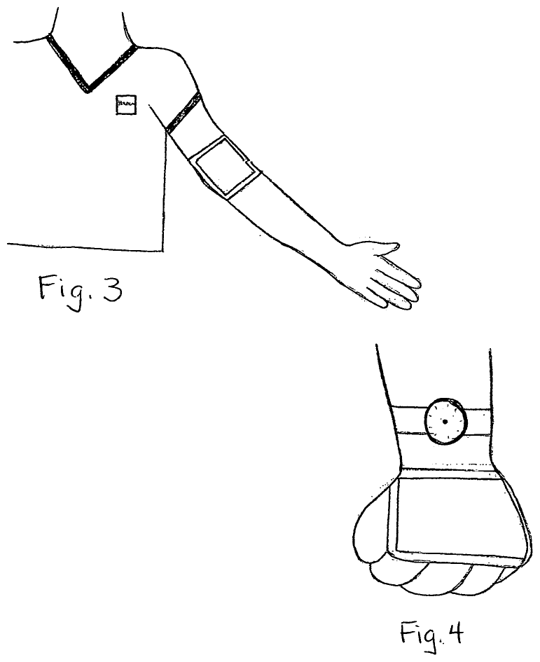

FIG. 3 is an overhead view of a medical training aid of FIG. 1 according to the preferred embodiment of the present invention, whereas the medical training aid is worn on the arm.

FIG. 4 is an overhead view of a medical training aid according to a further embodiment of the present invention, whereas the medical training aid is worn on the top of the hand.

It will be apparent to one with skill in the art that the medical training aid and method of the invention may be provided using some or all of the mentioned features and components without departing from the spirit and scope of the present invention. It will also be apparent that the embodiments described above are specific examples of a single broader invention that may have greater scope than any of the singular descriptions taught. There may be many alterations made in the descriptions without departing form the spirit and scope of the present invention.

What is claimed is:

1. A medical training aid to simulate a live, patient experience comprising:
a wearable apparatus, having multiple layers of materials, with a low profile almost flush to the skin, one layer having a hard surface membrane barrier to prevent needle penetration, fitting around an area of the body and worn by an individual, to simulate a live patient experience during education and/or training on medical needles, products or any other devices.

2. The medical training aid of claim 1, wherein one or more layers of the materials are combined and removed as one piece to allow the exterior of the apparatus to be washed and/or sanitized, or disposed of and replaced.

3. The medical training aid of claim 1, wherein the exterior layer is made of material visually depicting the anatomy of the body part in which the medical training aid is representing.
